(19) United States
(12) Patent Application Publication
(10) Pub. No.: US 2005/0041133 A1
(43) Pub. Date: Feb. 24, 2005

(54) Video-camera unit and adapter for a video-camera unit

(76) Inventor: Wolfgang Weigel, Ottobrunn (DE)

Correspondence Address: WOMBLE CARLYLE SANDRIDGE & RICE, P. O. Box 7037, Atlanta, GA, 30357-0037, US

(21) Appl. No.: 10/877,371

(22) Filed: Jun. 25, 2004

Related U.S. Application Data
(63) Continuation-in-part of application No. PCT/DE02/04665, filed on Dec. 19, 2002.

(30) Foreign Application Priority Data
Dec. 30, 2001 (DE) DE 10164138

(51) Int. Cl. H04N 5/225

(52) U.S. Cl. 348/335

(57) ABSTRACT

The following invention relates to an adapter for a video camera comprising a connection for a camera lens, a connection for a video camera, and an image transfer unit disposed between these two connections, wherein the image transfer unit has a photoreceptive surface and wherein the image transfer unit further comprises a beam splitter for branching off an optical viewfinder path. Furthermore, it relates to an adapter for a video camera comprising a connection for a camera lens, a connection for a video camera, and an image transfer unit disposed between these two connections, wherein the image transfer unit comprises a beam splitter for branching off an optical viewfinder path, and in the optical viewfinder path an optical deflection element is disposed which can be moved into and out of the optical viewfinder path, in such a way that the optical viewfinder image on the one hand and the image of a monitor on the other is able to be imaged into the eye of a user. Finally, it is related to corresponding video camera units.

### CROSS-REFERENCE TO RELATED APPLICATIONS

This application is a continuation of PCT/DE02/04665 (PCT/WO2002DE04665), filed on Dec. 19, 2002, designating the U.S., which claims the benefit of German Patent application no. DE10164138, filed on Dec. 30, 2001.

PCT/DE02/04665 (PCT/WO2002DE04665), filed on Dec. 19, 2002, and German Patent application no. DE10164138, filed on Dec. 30, 2001, are hereby incorporated herein by reference.

### BACKGROUND OF THE INVENTION

The present invention refers to video camera units and adapters for a video camera unit, especially relating to image transfer.

There is great economical interest of employing video shots in the production of feature or TV films, of advertising films etc. instead of conventional film material, since the cost for the film, the development and the possibly required “post-shooting” of— which usually only turns out after developing the film— “failed” shots present a substantial cost factor in production of a feature film. This is all so more true as video image receivers are already available due to the progress in the semiconductor technique, whose resolution is at least approximately comparable to that of conventional film material. Further, at least as experimental type, there are already video image receivers, the contrast scope of which is even higher than that of conventional “chemical” film.

However, the low-cost semiconductor exposure devices have a diagonal of the photosensitive area of clearly below one inch, mostly of the order of 1/3 inch or even less; thus, the diagonal of the photosensitive area is smaller than the diagonal of the images of a 35 mm cine film by factors. Thus, with the same angle of image, the lenses of video cameras must have a very much shorter focal length than the lenses of 35 mm cine cameras. Thereby, the focal depth of the scene exposed with a video camera clearly increases with respect to an exposure with a 35 mm cine camera. This may be of advantage in sports shots, however it is often undesirable in feature film productions etc. Therefore, until today, expensive productions also for TV are shot on 35 mm cine film, although the high resolution of the 35 mm film would not be required for TV productions.

For solving the problem of the “too high” focal depth, it has been proposed to use an optical adapter for a video camera, which has a camera lens for exposing a scene, the focal length of which corresponds to the camera lens of a conventional cine camera and the image field of which corresponds to the size of a conventional film. In the image plane of the camera lens, the photoreceptive surface of an image transfer unit is disposed. Thus, the screen image generated on the photoreceptive surface has the same focal depth as (e.g.) the image recorded on a 35 mm cine film. Further, a transfer lens is provided, which images the photoreceptive surface of the image transfer unit onto at least one video image receiver. Since a screen image and not an aerial image is imaged onto the video image receiver by the transfer lens, the focal depth of the exposed scene recorded by the video camera is only determined by the focal depth of the camera lens and not by the focal depth of the transfer lens.

However, the known adapters for video cameras do not nearly use the possibilities resulting from the two-step reproduction.

For example, besides the imaging properties of the camera lens and of the transfer lens, the optical properties of the photoreceptive surface or of the screen, respectively, are of critical importance for the image quality of the taken image.

Typical designs of the screens are matted surfaces (ground-glass plates) or fiber plates. Such screens result in perceivable granular structure in the image recorded by the video camera. Moreover, according to the scan theorem, in certain local frequencies, Moiré fringes can occur in the exposed scene.

From EP 0 950 912, an imaging device is known, which has a photoreceptive surface. It is proposed to adjust the focal depth by means of the diaphragm of an object-facing camera lens, wherein this adjusted focal depth is unchanged transferred by a transfer lens to a film or a CD.

The transfer lens can be used for compensating for the image brightness change caused by the camera lens.

From DE 100 20 307 A1, a device in imaging optical systems of a moving picture film exposing camera is known, wherein a device for improving image quality has a movably disposed light-transmitting disk in sandwich construction at adjustment disks in imaging optical systems of a cine camera. It is located in the viewfinder optical path and serves for image judgment.

From WO 02/069622 A1, a video camera and an adapter for a video camera are known, which also have a photoreceptive surface, in front of which in the optical path a camera lens and after which in the optical path a transfer lens are disposed. It is proposed to move the photoreceptive surface for preventing imaging of contaminations on the photoreceptive surface onto a semiconductor sensor field.

The use of an optical viewfinder in a video camera is known from JP 11146235 A. The optical viewfinder described there allows for alternatively viewing the optical viewfinder image and the image taken by the video image receiver.

Another video camera with an optical viewfinder assembly is known from DE 42 30 213 A1.

Another problem in generic video cameras is that commercial video cameras do not have an optical viewfinder.

### SUMMARY OF THE INVENTION

The invention is based on the object to develop a video camera unit configured such that the possibilities resulting from the two-step reproduction can be fully used. A further object consists in developing a generic adapter such that it has an optical viewfinder.

These objects are solved by an adapter having some or all of the features described herein. The embodiments described herein define inventive combinations as well as multiple, independent and/or partially independent inventions.

According to the invention, it has been recognized that in adapters with two-step reproduction the image transfer unit can also be used to realize an optical viewfinder, which is able to be retrofitted especially in a conventional video camera. An optical viewfinder is preferred by many camera people with respect to an electronic screen on which the video image is presented. Therein, the reflection can be effected in front of or behind the screen of the image transfer unit. Additionally and preferably, there results the possibility of switching between the optical image and the image taken by the video image receiver(s).

In each case, it is advantageous, if in the optical path, after the ground-glass plate or the fiber plate, a field lens is disposed, which increases the light flux.

If the camera lens has an adjustable diaphragm—this is the case in most of the commercial lenses for cine cameras—this diaphragm can substantially serve for adjusting the focal depth of the exposed scene and not for (finally) adjusting the image brightness on the video image receiver; the means for adjusting the image brightness are then provided in the optical path after the camera lens. The corresponding applies to a method for exposing a video film corresponding to a cine film on a video recording carrier.

Preferably, the means for adjusting the image brightness can be a diaphragm in the transfer lens. The camera man can then—of course, sufficient illumination of the scene provided—adjust the focal depth desired by the director by choice of the corresponding diaphragm at the camera lens. The control of the scene brightness is effected by adjusting the diaphragm in the transfer lens. Thus, for example in open-air shots, it is no longer required to move them to the morning or evening hours to have “sufficient little light” and thus a low focal depth. But primarily, with practically constant image brightness, the focal depth can be specifically changed during the shot by adjusting the diaphragm of the camera lens for changing the focal depth and by keeping the image brightness constant by oppositely directed adjustment of the diaphragm of the transfer lens. The adjustment of the diaphragm of the camera lens can be manually effected; therein, it is preferred if the video camera has diaphragm automatics for the transfer lens, which then keeps the image brightness constant.

Of course, it is also possible to use a controller, which effects a programmable, for example oppositely directed adjustment of the two diaphragms.

As diaphragms, in principle, all of the known diaphragms can be employed, for example and preferably iris diaphragms.

Alternatively, the means for adjusting the image brightness can have an adjusting means for the “sample time” (effective exposure time) of the video image receiver(s), which can specifically be CCD exposure devices. However, in contrast to the “diaphragm solution”, this embodiment is not realizable in each video camera.

According to the invention, at least the photoreceptive surface of the image transfer unit can be moved in the image plane of the camera lens, wherein the movement preferably is not effected step-wise. By the movement, the structures of the screen or of the photoreceptive surface of the image transfer unit, respectively, come to lie on different locations of the image plane or of the video image receiver in successive video images, respectively. Since the exposed scene remains stationary, of course, a viewer of the video film can no longer detect the structures in the video images presented to him consecutively. Namely, the human eye or the brain, respectively, have the property of not perceiving secondary structures moving independently of the scene and not belonging to the scene in moving scenes; thus, already comparatively low speeds or movement frequencies, which are below the image frequency, are sufficient to “mask” the structure of the screen for the viewer, i.e. to cause the viewer not to perceive the structure or granularity of the screen any longer, respectively.

As the forms of movement of the screen, very different forms are possible, wherein preferably it should be taken care that with uniform “granularity” of the screen, adjacent granules will not smear to one “line” by the movement direction.

For example, at least the photoreceptive surface of the image transfer unit can be rotatable. Therein, the rotation of the photoreceptive surface can be effected about the optical axis—but by means of expensive and largely constructing mechanics—or about an axis spaced from the optical axis. The second formation has the advantage that the moving mechanism can be constructed comparatively simple, however it is disadvantageous that the screen has to be comparatively large, and thereby also the space requirement is high.

The screen size and the space requirement are reduced, if the photoreceptive surface performs a tumbling movement or a preferably two-axis oscillating movement in the image plane. However, in such movements, the expense for the moving mechanism is higher than in a rotational movement.

As screens or photoreceptive surfaces of the image transfer unit, respectively, in principle, all screens etc. can be used, provided that a screen image with sufficient brightness and sharpness can be generated on them. Especially, a ground-glass plate or a fiber plate can be employed as screen, which is disposed in the image plane of the camera lens.

For shortening the optical path, the image transfer unit can have an image deflecting unit.

The basic thoughts according to the invention are in principle usable for simulating the focal depth of any cine cameras, thus for example of 16 mm or 70 mm cine cameras. However, it is especially preferred if they are used for simulating the focal depth of 35 mm cine cameras, i.e. if the size of the image field of the camera lens corresponds to the size of the image of a 35 mm cine film. In this case, as the camera lens, all of the lenses already present for 35 mm cine cameras can be used, wherein preferably a bayonet or “mount” is used for the exchangeable camera lens, respectively, as is also used in 35 mm cine cameras, so that it can be resorted to all of the present lenses.

As the video cameras, any video cameras and especially single-chip or three-chip cameras can be employed. In order to be able to make easy retrofit to present video cameras, it is further preferred if the camera lens and the image transfer unit are combined in a removable adapter. Then, the focal depth of for example a 35 mm cine camera is simulated with the adapter, without adapter, the video camera can then for example be employed for sports shots with high focal depth.

### DESCRIPTION OF THE DRAWINGS

Below, the invention is exemplarily described without limitation of the general spirit of invention by way of embodiments with reference to the drawing, to which incidentally reference is explicitly made with respect to the disclosure of all of the details according to the invention, which are not more detailed explained in the text. There show:

FIG. 1 a perspective, partially cut view of a video camera unit,

FIG. 2a a perspective view of a first embodiment of an adapter according to the invention with an optical viewfinder,

FIG. 2b a perspective view of a second embodiment of an adapter according to the invention with an optical viewfinder, and

FIG. 3 various possibilities of movement of the screen.

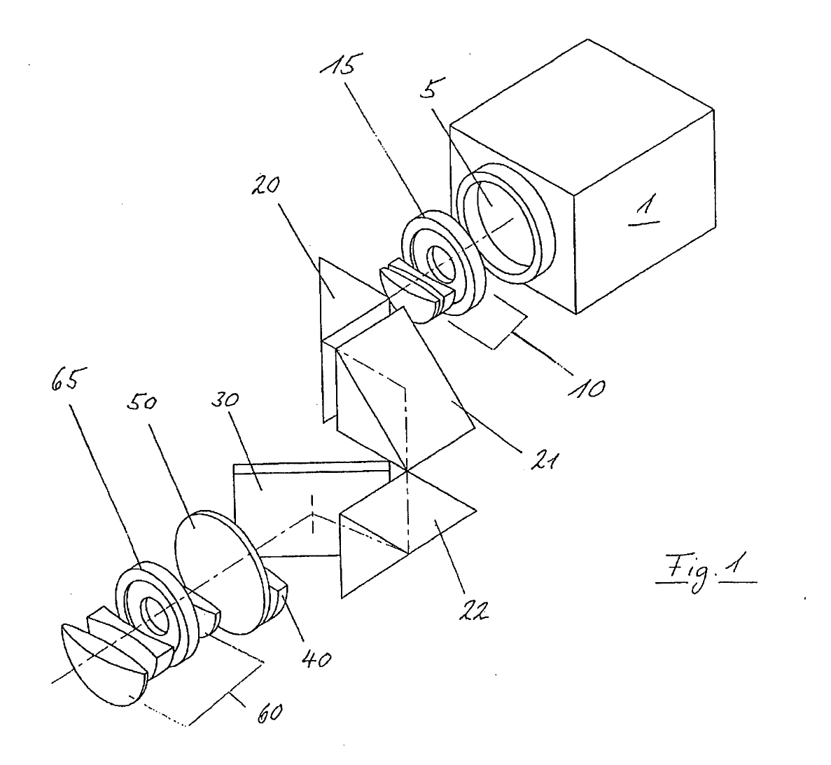

FIG. 1 shows a video camera 1. The video camera 1 has a video image receiver 5. Of course, also multiple exposure devices, for example three exposure devices with corresponding color masses, can be present. A transfer lens 10 with a diaphragm 15, which is preferably an iris diaphragm, is disposed in front of the exposure device 5.

The transfer lens 10 can be the lens of a commercial video camera or a special lens. In each case, the transfer lens 10 images a screen 50 (image transfer plate) via deflecting prisms 20 to 22 and a deflecting mirror 30 onto the video image receiver 5. By 40, a field lens associated with the screen 50 is designated. In the shown video camera, the deflecting prisms 20 to 22 and the deflecting mirror 30 serve for shortening the construction length or for image erection, respectively. Of course, a part or all of the deflecting members can be omitted if the construction length is not of importance. Further, a part of the deflections can be omitted if the image erection is effected electronically in the video camera 1.

The part of the screen 50 imaged onto the video image receiver by the transfer lens 10—i.e. the object field of the transfer lens 10— has in the shown embodiment without limitation of generality the size of a film image of a 35 mm cine camera. For generating the image on the screen 50, therefore, a camera lens 60 used commercially for 35 mm cine cameras and having a diaphragm 65 is provided, whose image field, i.e. the object field of the transfer lens 10, is optimized for the size of an image field of a 35 mm film. The camera lens 60 is preferably an exchangeable lens and can be a fixed focal length lens or a variable lens. The diaphragm 65 is preferably an iris diaphragm.

The screen 50 can for example be a ground-glass plate or a fiber plate. Ground-glass plates or fiber plates, but also other sheets suitable for generating a screen image, have a structure which can possibly be perceivable in the recorded video image, but at least leaves a disturbing, smeared or blurred impression, respectively. In order to prevent the structure in the recorded video film to be perceivable for a viewer of the film, according to the invention, the screen 50 is moved in the image plane of the camera lens 60, thus in the direction orthogonally to the optical axis, which is shown dash-dotted.

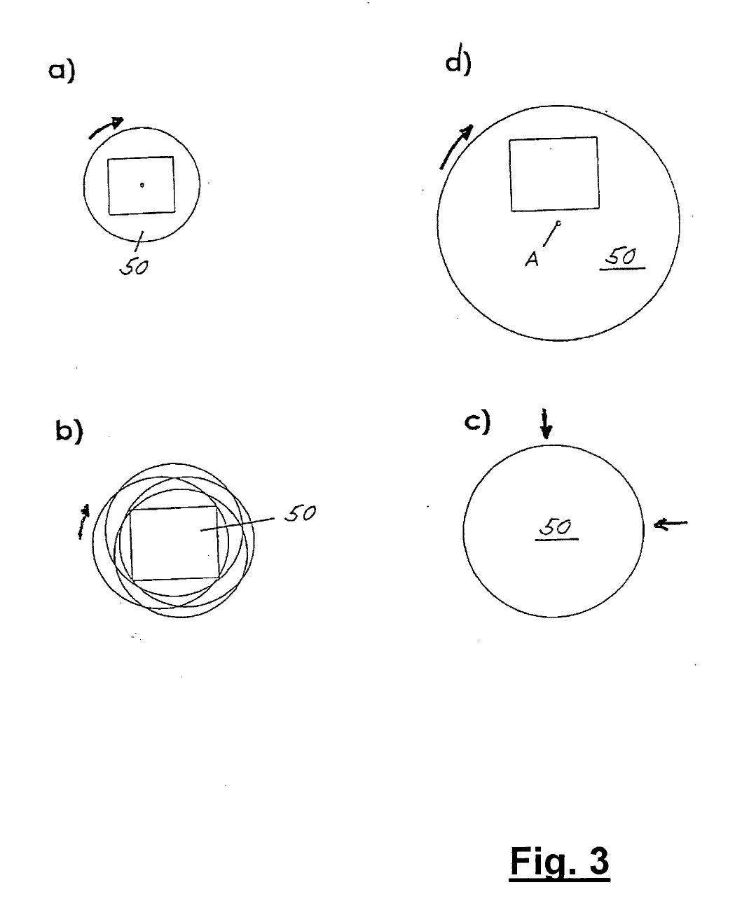

Possibilities of movement of the screen 50 will be explained in conjunction with FIG. 3.

Furthermore, by the two-step reproduction, the following possibility results: the size of the diaphragm 65 in the camera lens 60 is chosen without considering the image brightness substantially such that the focal depth of the exposed scene corresponds to the dictations of the director. The control of the scene brightness is then effected by adjusting the diaphragm 15 in the transfer lens 10. Since the transfer lens images a screen image and not an aerial image, the focal depth of the transfer lens 10 is not of importance, so that the focal depth of the exposed scene is determined exclusively by the diaphragm size of the camera lens 60. Of course, the size of the diaphragm 65 cannot be chosen such that already with maximum opening of the diaphragm 15, a too dark image results; however, just in cine exposure, the problem is not “too little light”, but “too much light”.

However, primarily, with practically constant image brightness, the focal depth can be specifically changed during the exposure by adjusting the diaphragm 65 of the camera lens 60 for changing the focal depth, and by keeping the image brightness constant by an oppositely directed adjustment of the diaphragm 15 of the transfer lens 10. The adjustment of the diaphragm of the camera lens can be effected manually; therein, it is preferred if the video camera 1 has an automatic diaphragm control for the transfer lens 10, which then keeps the image brightness constant.

Of course, it is also possible to use a controller, which effects a programmable, for example oppositely directed adjustment of the two diaphragms 15 and 65.

All parts except for the video camera 1 and the exposure device 5 can be combined in a removable adapter for a video camera. Of course, it is also possible to employ the standard lens of the video camera 1 as the lens 10, and to install only the parts 20 to 65 in FIG. 1 in the adapter.

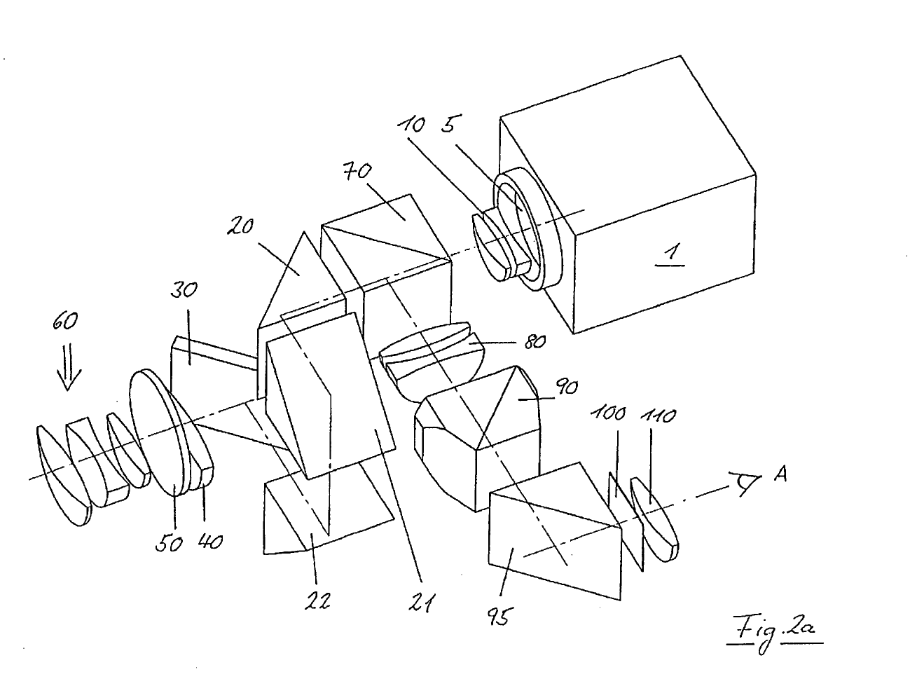

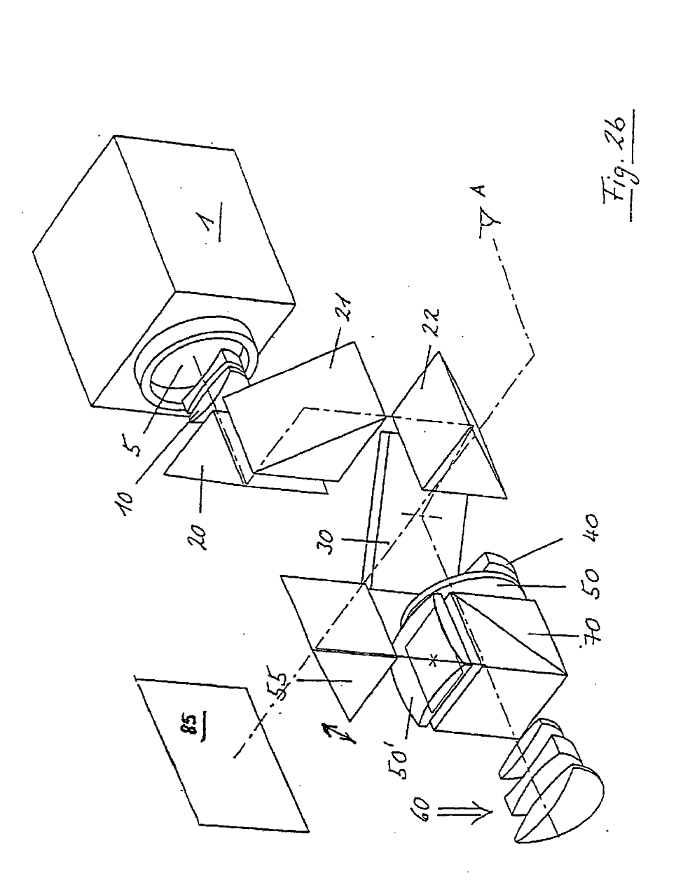

FIGS. 2a and 2b show embodiments of the invention, wherein the adapter serves for providing an optical viewfinder for a commercial video camera not provided with an optical viewfinder.

The two shown embodiments differ in that a beam splitter 70 for the optical viewfinder optical path is disposed on the one hand behind the screen 50 (FIG. 2a) and on the other hand in front of the screen 50 (FIG. 2b). The same parts as in FIG. 1 are provided with the same reference symbols in FIGS. 2a and 2b, so that a repeated presentation is omitted.

In the embodiment shown in FIG. 2a, the beam splitter 70 is disposed between the deflecting prism 20 and the transfer lens 10. The part of the light reflected out of the recording optical path to the optical viewfinder, crosses transfer optics 80 and a prism 90 and is then imaged to the viewfinder intermediate image 100 by a deflecting prism 95. The intermediate image 100 can be viewed by an eye A through an eyepiece 100.

In the embodiment shown in FIG. 2b, the beam splitter 70 is disposed between the camera lens 60 and the screen 50. In a position conjugated to the position of the screen 50, there is another screen 50′ having a format designation corresponding to the size of the exposed image.

After deflection via a prism 55, the optical path of the optical viewfinder largely corresponds to the optical path illustrated in FIG. 2a, so that its illustration is omitted.

In FIG. 2b, alternatively, an embodiment is shown, wherein the prism 55 is movable out of the optical path. Once the prism 55 moved out of the optical path, a monitor 85, for example an LCD monitor, is viewed through the optical viewfinder, on which exposure data and/or the image taken by the video image receiver(s) is represented. Thereby it is possible to alternatively view the optical viewfinder image and the electronically taken image.

FIG. 3 shows not finally various possibilities of movement of the screen 50 in the image plane of the camera lens 60, wherein in the partial figures a and b the format limitation of the image is given:

In the partial image a, as one possibility, a rotation about the optical axis of the optical system, and especially of the camera lens 60, is shown. The partial image a' shows as another possibility a rotation about an axis A parallel to the optical axis and spaced from the optical axis.

The partial image b shows as another possibility that the screen 50 is eccentrically rotatable about or outside the optical axis. Such a movement is referred to as tumbling movement in the image plane. In the partial image c, a movement of the screen 50 oscillating in two directions is illustrated.

Above, the invention has been described by way of embodiments without limitation of the general applicability and the general spirit of invention and possibly independently patentable developments: for example, also in the camera lenses 60 and transfer lenses 10 shown in FIGS. 2a and 2b, diaphragms can be present, wherein the diaphragms can specifically be iris diaphragms.

1. Adapter for a video camera comprising
a connection for a camera lens,
a connection for a video camera, and
an image transfer unit disposed between these two connections, wherein the image transfer unit has a photoreceptive surface, and
wherein the image transfer unit further comprises a beam splitter for branching off an optical viewfinder path.

2. Adapter according to claim 1, wherein
the photoreceptive surface is disposed in the image plane of the camera lens to be connected to the connection for a camera lens, in such a way that the photoreceptive surface is able to be imaged onto at least one video image receiver with a transfer lens to be connected to the connection for a video camera.

3. Adapter according to claim 2, wherein
the beam splitter is disposed in the optical path between the connection for the camera lens and the photoreceptive surface.

4. Adapter according to claim 2, wherein
the beam splitter is disposed in the optical path between the photoreceptive surface and the connection for the video camera.

5. Adapter according to claim 4, wherein
in the optical viewfinder path a screen with a format mark is disposed.

6. Adapter according to claim 4, wherein
in the optical viewfinder path a prism is disposed, which can be moved into and out of the optical viewfinder path, in such a way that on the one hand the optical viewfinder image and on the other hand the image of a monitor are able to be imaged into the eye of a user.

7. Adapter according to claim 5, wherein
in the optical viewfinder path a prism is disposed, which can be moved into and out of the optical viewfinder path, in such a way that on the one hand the optical viewfinder image and on the other hand the image of a monitor are able to be imaged into the eye of a user.

8. Video camera unit comprising
a camera lens,
an image transfer unit, the image transfer unit having a photoreceptive surface, and
a transfer lens imaging the photoreceptive surface of the image transfer unit onto at least one video image receiver,
wherein the image transfer unit further comprises a beam splitter for branching off an optical viewfinder path.

9. Adapter for a video camera comprising
a connection for a camera lens,
a connection for a video camera, and
an image transfer unit disposed between these two connections,
wherein
the image transfer unit comprises a beam splitter for branching off an optical viewfinder path, and
that in the optical viewfinder path an optical deflection element is disposed which can be moved into and out of the optical viewfinder path, in such a way that the optical viewfinder image on the one hand and the image of a monitor on the other is able to be imaged into the eye of a user.

10. Video camera unit with
a camera lens,
at least one video image receiver, and
an image transfer unit disposed between the camera lens and the at least one video image receiver,
wherein
the image transfer unit comprises a beam splitter for branching off an optical viewfinder path, and
that in the optical viewfinder path an optical deflection element is disposed, which can be moved into and out of the optical viewfinder path, in such a way that the optical viewfinder image on the one hand and the image of a monitor on the other is able to be imaged into the eye of a user.
